(19) United States
(12) Patent Application Publication
(10) Pub. No.: US 2023/0096501 A1
(43) Pub. Date: Mar. 30, 2023

(54) COMPUTER-READABLE RECORDING MEDIUM STORING CALCULATION PROGRAM, CALCULATION METHOD, AND INFORMATION PROCESSING DEVICE

(71) Applicant: FUJITSU LIMITED, Kawasaki-shi (JP)

(72) Inventor: Takahisa YAMAMOTO, Fuchu (JP)

(73) Assignee: FUJITSU LIMITED, Kawasaki-shi (JP)

(21) Appl. No.: 18/060,304

(22) Filed: Nov. 30, 2022

Related U.S. Application Data
(63) Continuation of application No. PCT/JP2020/029581, filed on Jul. 31, 2020.

(51) Int. Cl. G06V 40/16; G06V 10/25; G06V 10/77; G06V 10/74

(52) U.S. Cl. CPC G06V 40/171; G06V 10/25; G06V 10/7715; G06V 10/74; G06V 40/176; G06Q 50/10

(57) ABSTRACT

A non-transitory computer-readable recording medium stores a calculation program for causing a computer to execute processing including: acquiring a captured image that includes a face; determining an occurrence state of a movement of a facial muscle, based on the captured image; and calculating a matching degree between the face and a specific fashion style, based on the occurrence state of the movement of the facial muscle.

### CROSS-REFERENCE TO RELATED APPLICATION

This application is a continuation application of International Application PCT/JP2020/029581 filed on Jul. 31, 2020 and designated the U.S., the entire contents of which are incorporated herein by reference.

### FIELD

The embodiment discussed herein is related to a calculation technology.

### BACKGROUND

In recent years, data learning techniques have been widespread in image recognition techniques, and it has been possible to recognize various objects from data with high accuracy in an End-to-End manner. On the other hand, in fields related to human sensibility, there are unresearched and undeveloped fields. For example, fashion style coordination or the like is one example of the above fields.

Japanese Patent No. 6604644 and Japanese Laid-open Patent Publication No. 2009-223740 are disclosed as related art.

### SUMMARY

According to an aspect of the embodiments, a non-transitory computer-readable recording medium stores a calculation program for causing a computer to execute processing including: acquiring a captured image that includes a face; determining an occurrence state of a movement of a facial muscle, based on the captured image; and calculating a matching degree between the face and a specific fashion style, based on the occurrence state of the movement of the facial muscle.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is an explanatory diagram illustrating an example of a calculation method according to an embodiment;

FIG. 1B is an explanatory diagram illustrating a value of each action unit;

FIG. 2 is an explanatory diagram illustrating a system configuration example of an information processing system 200;

FIG. 3 is a block diagram illustrating a hardware configuration example of an information processing device 101;

FIG. 4 is an explanatory diagram illustrating an example of storage content of a style dictionary DB 220;

FIG. 5 is a block diagram illustrating a functional configuration example of the information processing device 101;

FIG. 6 is an explanatory diagram illustrating an extraction example of parts;

FIG. 7 is a flowchart illustrating an example of a first calculation processing procedure of the information processing device 101;

FIG. 8 is an explanatory diagram (part 1) illustrating a screen example of an output screen;

FIG. 9 is a flowchart illustrating an example of a second calculation processing procedure of the information processing device 101; and

FIG. 10 is an explanatory diagram (part 2) illustrating the screen example of the output screen.

### DESCRIPTION OF EMBODIMENTS

There is related art that determines a face impression type of a subject based on an acquired face image, determines a skeleton type of the subject based on acquired skeleton information, and determines a basic fashion type of the subject from the determined face impression type and skeleton type with reference to a basic fashion type database. Furthermore, there is a technique for acquiring a feature amount representing a feature of a face from an input face image and searching for a clothing item that matches the acquired feature amount, with reference to a face-item database DB that associates compatibility between various feature amounts and various clothing items.

However, with the related art, it is not possible to determine whether or not a face of a target person matches a target fashion style.

In one aspect, an object of the embodiment is to calculate a matching degree between a face and a specific fashion style.

Hereinafter, an embodiment of a calculation program, a calculation method, and an information processing device will be described in detail with reference to the drawings.

### Embodiment

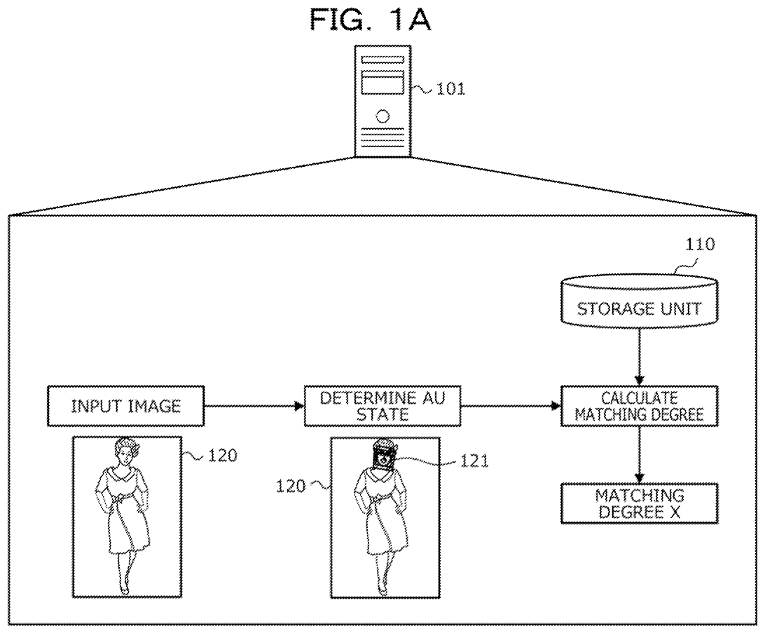

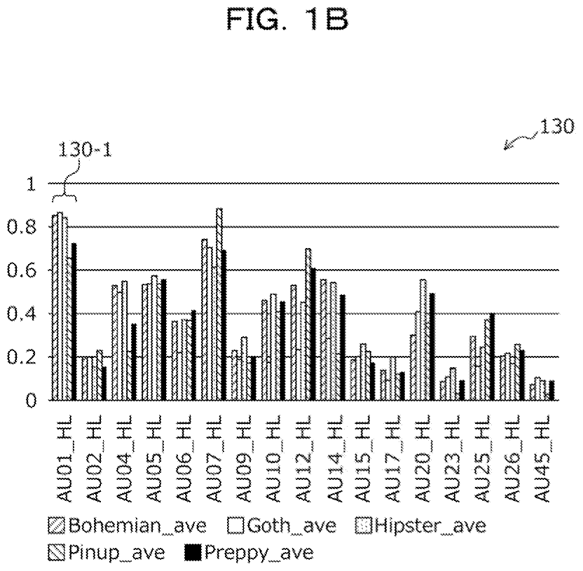

FIG. 1A is an explanatory diagram illustrating an example of a calculation method according to an embodiment. In FIG. 1A, an information processing device 101 is a computer that calculates a matching degree between a face and a fashion style. The matching degree is an index value that indicates how much an impression of the face matches a specific fashion style.

The fashion style is a type of clothing. The fashion style is, for example, the Bohemian style, the Goth style, the Hipster style, the Preppy style, the Pinup style, or the like.

The impression of the face is correlated with the matching degree with the fashion style. For example, some fashion styles suit the impression of the face, and some fashion styles do not. Therefore, it is convenient if it can be quantitatively determined how much the impression of the face matches a target fashion style.

For example, about a photograph to be published in a fashion magazine, it is useful in a case where it is desired to objectively evaluate how much an impression of a face of a model matches a target fashion style. Furthermore, it is useful in a case where a user himself/herself wants to know how much an impression of his/her own face matches a certain fashion style.

However, from a contour of the face or a shape of a part of the face, it is not possible to sufficiently specify the impression of the face. For example, only from the contour of the face or the shapes of the eyes or nose, it is difficult to specify an impression at a degree at which a correlation with a matching degree with a fashion style can be determined.

Here, a value of an action unit (AU) is an index representing a muscle condition of a face. The action unit is a quantified movement of a facial muscle, and for example, the action units are classified into about 30 types based on movements of the respective muscles of the face such as lowering the eyebrows or raising the cheeks. The facial muscle is a general term of muscles concentrated around the eyes, the nose, and the mouth, for example.

For example, there are action units 1 to 46 including missing numbers. By combining these action units, subtle expression changes can be captured. For example, a happy or joyful expression is determined from a combination of the action unit 6 (cheek raiser: raise cheek) and the action unit 12 (Lip Corner Puller: pull lip corner).

The values of the action units depend on individuals even with no expression. Therefore, for example, a value of an action unit when a person is expressionless can be used as a value representing an impression of the person's face.

Therefore, in the present embodiment, a calculation method for estimating an impression of a face using a value of an action unit and calculating a matching degree indicating how much the impression of the face matches a specific fashion style will be described. Hereinafter, a processing example of the information processing device 101 will be described.

(1) The information processing device 101 acquires a captured image including a face. The face included in the captured image is a face of a target person whose matching degree with a specific fashion style is determined. The captured image may include, for example, clothing and hair of the target person.

In the example in FIG. 1A, a case is assumed where an input image 120 is acquired. The input image 120 is a captured image including the face, the hair, and the clothing of the target person.

(2) The information processing device 101 determines an occurrence state of movements of facial muscles, based on the acquired captured image. Here, the occurrence state of the movements of the facial muscles may indicate, for example, whether or not a certain muscle of the face moves or a size of a movement of a certain muscle of the face.

The movement of the facial muscle is, for example, an action unit. An occurrence state of the action unit indicates, for example, whether or not a certain muscle of the face moves (occurrence). Furthermore, the occurrence state of the action unit may indicate, for example, the value of the action unit itself (intensity).

The value of the action unit can be obtained by executing image recognition processing on the captured image including the face. For example, the information processing device 101 may calculate the value of each action unit based on the acquired captured image, using an existing expression analysis tool.

For example, if the value of the action unit is equal to or more than a predetermined threshold, the information processing device 101 may determine that a movement of a muscle corresponding to the action unit occurs. On the other hand, if the value of the action unit is less than the threshold, the information processing device 101 determines that the movement of the muscle corresponding to the action unit does not occur.

In the example in FIG. 1A, from a face region 121 included in the input image 120, an occurrence state of each action unit (for example, AU01 to AU45 illustrated in FIG. 1B to be described later) is determined.

(3) The information processing device 101 calculates a matching degree between a face and a specific fashion style based on the determined occurrence state of the movement of the facial muscle. The specific fashion style can be, for example, optionally designated. Furthermore, the specific fashion style may be specified from the clothing included in the acquired captured image.

Here, a value of each action unit calculated from a captured image including a face that matches each fashion style will be described with reference to FIG. 1B. The captured image including the face that matches the fashion style is a captured image including a face having an impression that matches the fashion style.

FIG. 1B is an explanatory diagram illustrating a value of each action unit. In FIG. 1B, a graph 130 illustrates a value of each action unit (AU01 to AU45) calculated from a captured image including a face that matches each fashion style, for each of fashion styles including Bohemian, Goth, Hipster, Pinup, and Preppy.

For example, five bar graphs 130-1 indicate the values of AU01 corresponding to the fashion styles of Bohemian, Goth, Hipster, Pinup, and Preppy in order from left. Each value of the AU is, for example, an average of values calculated from hundreds of captured images including the face that matches the fashion style.

As illustrated in the graph 130, the value of each action unit varies depending on the fashion style. For example, depending on the fashion style, a value of a certain action unit is higher or lower than that of another fashion style. For example, it can be said that characteristics of the impression of the face that matches the fashion style appear in the value of the action unit.

Therefore, the information processing device 101 calculates a first feature vector representing an impression of a face, for example, based on the occurrence state of the action unit. The first feature vector is, for example, a vector whose element is the occurrence state of each of the action units (AU01 to AU45).

Next, the information processing device 101 refers to a storage unit 110 that stores a first dictionary vector representing an impression of a face that matches a specific fashion style and specifies the first dictionary vector. The first dictionary vector is generated based on the occurrence state of the action unit (movement of facial muscle) based on the captured image including the face that matches the specific fashion style.

Then, the information processing device 101 may calculate a matching degree between the face and the specific fashion style, based on the calculated first feature vector and the first dictionary vector. For example, the information processing device 101 calculates an inner product of the first feature vector and the first dictionary vector and calculates the matching degree between the face and the specific fashion style.

In the example in FIG. 1A, when it is assumed that the specific fashion style be the “Bohemian style”, a matching degree X between the face included in the input image 120 with the Bohemian style is calculated. A larger value of the matching degree X indicates, for example, a higher matching degree with the Bohemian style. Furthermore, a smaller value of the matching degree X indicates a lower matching degree with the Bohemian style.

In this way, according to the information processing device 101, it is possible to quantitatively evaluate how much the impression of the face of the target person matches the specific fashion style, from the captured image including the face of the target person. As a result, for example, it is possible to objectively evaluate how much the impression of the face of the model matches the target fashion style, and it is possible to check content of a photograph to be published in a fashion magazine.

(System Configuration Example of Information Processing System 200)

Next, a system configuration example of an information processing system 200 including the information processing device 101 illustrated in FIG. 1A will be described. The information processing system 200 is applied to, for example, a service that enables to check how much an impression of a face of a person imaged in a photograph matches a specific fashion style.

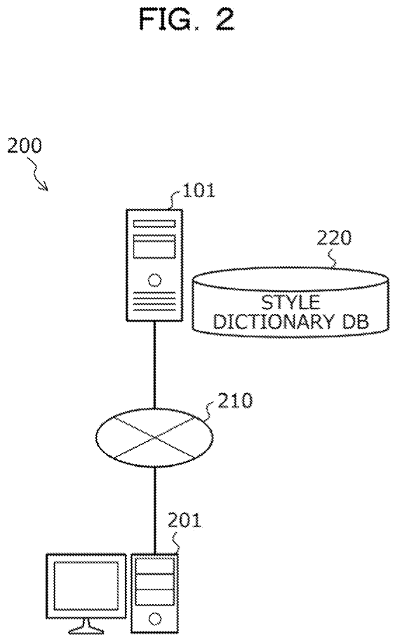

FIG. 2 is an explanatory diagram illustrating the system configuration example of the information processing system 200. In FIG. 2, the information processing system 200 includes the information processing device 101 and a client device 201. In the information processing system 200, the information processing device 101 and the client device 201 are connected via a wired or wireless network 210. The network 210 is, for example, the Internet, a local area network (LAN), a wide area network (WAN), or the like.

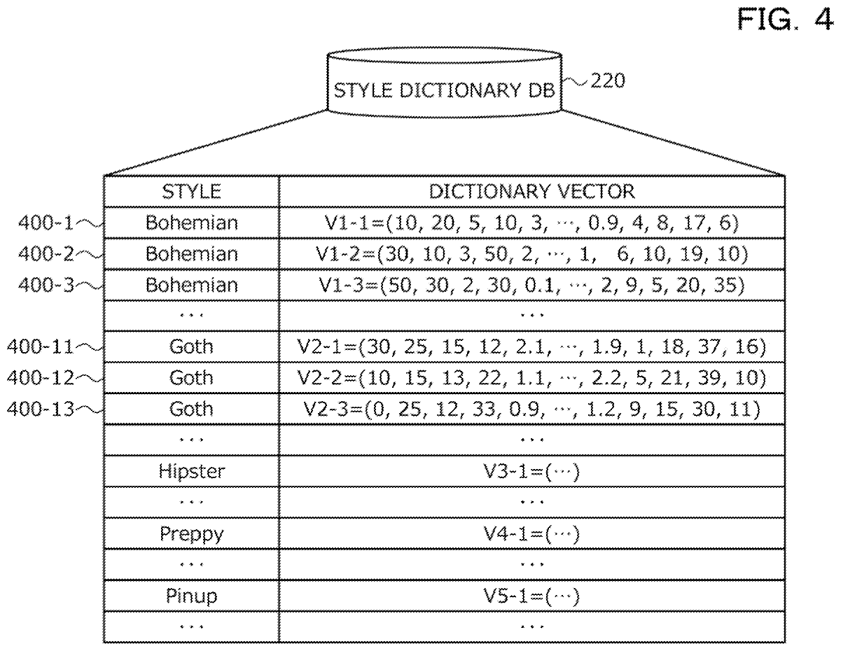

Here, the information processing device 101 includes a style dictionary database (DB) 220 and calculates a matching degree between a face and a fashion style. The information processing device 101 is, for example, a server. Storage content of the style dictionary DB 220 will be described later with reference to FIG. 4. The storage unit 110 illustrated in FIG. 1A corresponds to, for example, the style dictionary DB 220.

The client device 201 is a computer used by a user. The user is, for example, a person who checks how much the impression of the face of the target person matches the specific fashion style. The client device 201 is, for example, a personal computer (PC), a tablet PC, a smartphone, or the like.

Note that, in the example in FIG. 2, only one client device 201 is illustrated, but the number of client devices 201 is not limited to this. For example, the information processing system 200 may include a plurality of the client devices 201. Furthermore, the information processing device 101 is provided separately from the client device 201. However, the embodiment is not limited to this. For example, the information processing device 101 may be implemented by the client device 201.

(Hardware Configuration Example of Information Processing Device 101)

Next, a hardware configuration example of the information processing device 101 will be described.

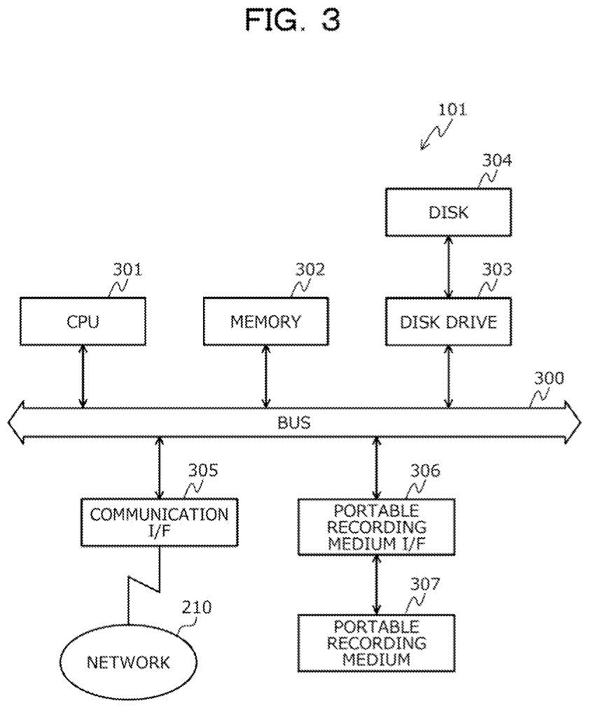

FIG. 3 is a block diagram illustrating the hardware configuration example of the information processing device 101. In FIG. 3, the information processing device 101 includes a central processing unit (CPU) 301, a memory 302, a disk drive 303, a disk 304, a communication interface (I/F) 305, a portable recording medium I/F 306, and a portable recording medium 307. Furthermore, the individual components are connected to each other by a bus 300.

Here, the CPU 301 performs overall control of the information processing device 101. The CPU 301 may include a plurality of cores. The memory 302 includes, for example, a read only memory (ROM), a random access memory (RAM), a flash ROM, or the like. For example, the flash ROM stores an operating system (OS) program, the ROM stores an application program, and the RAM is used as a work area for the CPU 301. A program stored in the memory 302 is loaded into the CPU 301 to cause the CPU 301 to execute coded processing.

The disk drive 303 controls read/write of data from/to the disk 304 under the control of the CPU 301. The disk 304 stores data written under the control of the disk drive 303. Examples of the disk 304 include a magnetic disk, an optical disk, or the like.

The communication I/F 305 is connected to the network 210 through a communication line, and is connected to an external computer (for example, client device 201 illustrated in FIG. 2) via the network 210. Then, the communication I/F 305 manages an interface between the network 210 and the inside of the device, and controls input and output of data from an external computer. For example, a modem, a LAN adapter, or the like may be employed as the communication I/F 305.

The portable recording medium I/F 306 controls read/write of data from/to the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, or the like.

Note that the information processing device 101 may include, for example, a solid state drive (SSD), an input device, a display, or the like in addition to the components described above. Furthermore, the information processing device 101 does not need to include, for example, the disk drive 303, the disk 304, the portable recording medium I/F 306, and the portable recording medium 307 of the components described above. Furthermore, the client device 201 illustrated in FIG. 2 can be implemented by a hardware configuration similar to that of the information processing device 101. However, the client device 201 includes, for example, an input device, a display, a camera (imaging device), or the like, in addition to the components described above.

(Storage Content of Style Dictionary DB 220)

Next, the storage content of the style dictionary DB 220 included in the information processing device 101 will be described with reference to FIG. 4. The style dictionary DB 220 is implemented by, for example, a storage device such as the memory 302 or the disk 304 illustrated in FIG. 3.

FIG. 4 is an explanatory diagram illustrating an example of the storage content of the style dictionary DB 220. In FIG. 4, the style dictionary DB 220 includes fields of a style and a dictionary vector, and stores style dictionary information (for example, style dictionary information 400-1 to 400-3) as records by setting information to each field.

Here, the style indicates a fashion style. Here, the style indicates one of the fashion styles of Bohemian, Goth, Hipster, Preppy, and Pinup. The dictionary vector is a feature vector representing an impression of a face that matches each fashion style.

The dictionary vector is, for example, a 40-dimensional feature vector. For example, the dictionary vector includes an element (three dimensions) regarding a hair color, an element (one dimension) regarding a hair length, an element (32 dimensions) regarding an occurrence state of an action unit, and an element (four dimensions) regarding positions of face parts.

Each dictionary vector is, for example, generated based on a captured image including a face and hair that match each fashion style and clothing of the fashion style. Furthermore, for example, a captured image including an expressionless face is used to generate the dictionary vector. Furthermore, a plurality of captured images including a face of the same person with various expressions may be used to generate the dictionary vector. In this case, a value of each element of the dictionary vector may be, for example, an average of values based on each of the plurality of captured images.

For example, the style dictionary information 400-1 indicates a dictionary vector V1-1 generated based on a captured image including a face and hair that match the Bohemian style and clothing in the Bohemian style. V1-1 is “V1-1=(10, 20, 5, 10, 3, . . . , 0.9, 4, 8, 17, 6)”.

(Functional Configuration Example of Information Processing Devices 101)

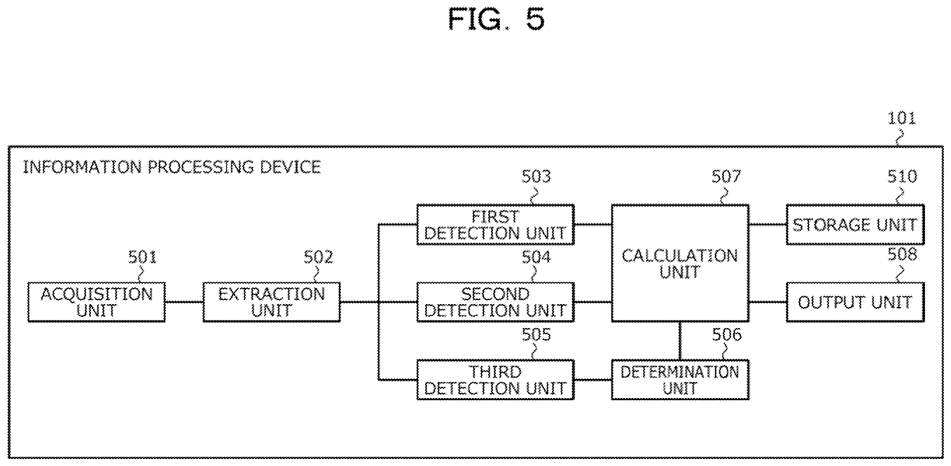

FIG. 5 is a block diagram illustrating a functional configuration example of the information processing device 101. In FIG. 5, the information processing device 101 includes an acquisition unit 501, an extraction unit 502, a first detection unit 503, a second detection unit 504, a third detection unit 505, a determination unit 506, a calculation unit 507, an output unit 508, and a storage unit 510. The acquisition unit 501 to output unit 508 have functions serving as a control unit, and for example, those functions are implemented by the program stored in a storage device such as the memory 302, disk 304, or portable recording medium 307 illustrated in FIG. 3 executed by the CPU 301 or by the communication I/F 305. A processing result of each functional unit is stored in, for example, the storage device such as the memory 302 or the disk 304. The storage unit 510 is implemented by, for example, the storage device such as the memory 302 or the disk 304. For example, the storage unit 510 stores the style dictionary DB 220 illustrated in FIG. 4.

The acquisition unit 501 acquires a captured image including a face. The captured image is, for example, a photograph that includes a face of a target person imaged by an imaging device (not illustrated). The captured image includes, for example, hair and clothing corresponding to the face of the target person. As the captured image, for example, a captured image including a face in an expressionless state is used.

In the following description, the captured image including the face, the hair, and the clothing of the target person may be referred to as an “input image P”.

For example, the acquisition unit 501 acquires the input image P, by receiving the input image P from the client device 201 illustrated in FIG. 2. Furthermore, the acquisition unit 501 may acquire the input image P by a user's operation input using an input device (not illustrated).

The extraction unit 502 extracts a part from the acquired captured image. Here, a part to be extracted is, for example, a face region, a hair region, a clothing region, or the like of the target person. For example, the extraction unit 502 extracts a part of the target person from the acquired input image P with a machine learning method such as deep learning.

More specifically, for example, the extraction unit 502 extracts the face region, the hair region, and the clothing region of the target person, using semantic segmentation. The semantic segmentation is a deep learning algorithm that associates labels or categories with all pixels in an image. For example, JPPNet is a method of the semantic segmentation.

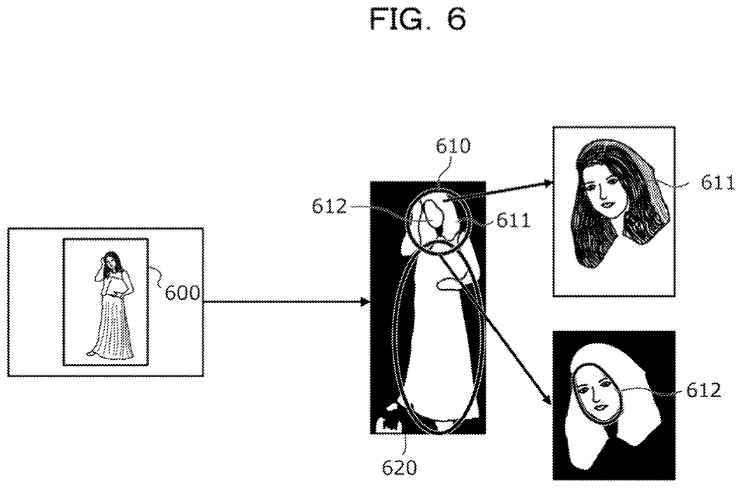

Here, an example of extraction of parts from the input image P will be described with reference to FIG. 6.

FIG. 6 is an explanatory diagram illustrating an extraction example of parts. In FIG. 6, an input image 600 is an example of the input image P including the face, the hair, and the clothing of the target person. Here, from the input image 600, a head region 610 and a clothing region 620 are extracted. Furthermore, a hair region 611 and a face region 612 of the head region 610 are extracted.

Returning to the description of FIG. 5, the first detection unit 503 detects an expression of a face. For example, the first detection unit 503 determines an occurrence state of a movement of a facial muscle based on the acquired captured image. Here, the movement of the facial muscle is, for example, an action unit. The occurrence state of the action unit may indicate, for example, whether or not a movement of a certain muscle of the face occurs or may indicate the value of the action unit itself.

In the following description, an “action unit” will be described as an example of the movement of the facial muscle. Furthermore, there is a case where the occurrence state of the action unit is referred to as an “AU value”. The AU value indicates a value of the action unit.

More specifically, for example, the first detection unit 503 may calculate each AU value based on the extracted face region, using an existing expression analysis tool. For example, there are AUs 1 to 46, and there are 32 types of AUs if missing numbers are excluded. In this case, 32 AU values are calculated.

The second detection unit 504 detects a feature amount of a hair region from the acquired captured image. For example, the second detection unit 504 detects the feature amount of the hair region from the extracted hair region. Here, the hair region is a hair region corresponding to the face of the target person. The feature amount of the hair region is, for example, information representing a hair color. More specifically, for example, the feature amount of the hair region may be an average color (RGB value) of the hair region.

Furthermore, the feature amount of the hair region may be information representing a hair length or amount. More specifically, for example, the feature amount of the hair region may be a ratio of the hair region with respect to the head region including the hair region and the face region. The ratio of the hair region with respect to the head region is represented, for example, by a pixel occupancy ratio (the number of pixels in hair region/the number of pixels in head region).

The third detection unit 505 detects a feature amount of the clothing region from the acquired captured image. For example, the third detection unit 505 detects the feature amount of the clothing region from the extracted clothing region. Here, the clothing region is a region of clothing corresponding to the face of the target person. The feature amount of the clothing region is, for example, information representing a color or a shape of the clothing.

Furthermore, the first detection unit 503 detects, for example, a feature amount of a face part from the acquired captured image. For example, the first detection unit 503 detects the feature amount of the face part from the extracted face region. Here, the face part is a part of the face of the target person and is, for example, the eyes, the nose, the mouth, the eyebrows, or the like. The feature amount of the face part is, for example, information representing a position of the face part in the face of the target person.

More specifically, for example, the first detection unit 503 may detect a distance of the face part from an origin of the face region as the feature amount of the face part. The origin can be optionally set and is, for example, set to a nose tip (top of nose) or the like. For example, the first detection unit 503 may detect a distance (the number of pixels) from the origin to an outer corner of the left eye as a feature amount representing a position of the eye (eye_location).

Furthermore, the first detection unit 503 may detect a distance from the origin to the nose tip as a feature amount representing a position of the nose (nose_location). Furthermore, the first detection unit 503 may detect a distance from the origin to the center of the upper lip as a feature amount representing a position of the mouth (mouth_location). Furthermore, the first detection unit 503 may detect a distance from the origin to the center of the left eyebrow as a feature amount representing a position of the eyebrow (eyebrow_location).

The determination unit 506 determines a fashion style corresponding to the extracted clothing region. For example, the determination unit 506 determines the fashion style corresponding to the clothing region, based on the detected feature amount of the clothing region. More specifically, for example, the determination unit 506 determines the fashion style corresponding to the clothing region, based on the detected feature amount of the clothing region, using a machine learning model.

The machine learning model outputs one of the fashion styles of Bohemian, Goth, Hipster, Preppy, and Pinup, as an input of the feature amount of the clothing region. The machine learning model is generated through machine learning such as deep learning, for example, using clothing image information to which a label indicating a fashion style is given as learning data (teacher data).

The calculation unit 507 calculates a matching degree between a face and a specific fashion style based on the occurrence state of the action unit. The specific fashion style can be, for example, optionally designated. For example, the calculation unit 507 may receive designation of the specific fashion style from the client device 201.

Furthermore, the calculation unit 507 may assume the fashion style determined by the determination unit 506 as the specific fashion style. Furthermore, the calculation unit 507 may select each of the fashion styles including Bohemian, Goth, Hipster, Preppy, and Pinup as the specific fashion style, by referring to the style dictionary DB 220 illustrated in FIG. 4.

For example, the calculation unit 507 calculates a first feature vector representing an impression of the face, based on the occurrence state of the action unit. The first feature vector is, for example, a 32-dimensional vector (AU01_value, AU02_value, . . . , to AU46_value) whose elements are 32 types of calculated AU values (AU01, AU02, . . . , to AU46).

Furthermore, the calculation unit 507 refers to the storage unit 510 and specifies the first dictionary vector representing the impression of the face that matches the specific fashion style. The storage unit 510 stores the first dictionary vector representing the impression of the face that matches the specific fashion style. The first dictionary vector is generated based on the occurrence state of the action unit based on the captured image including the face that matches the specific fashion style. For example, the first dictionary vector is a 32-dimensional vector whose elements are 32 types of respective AU values.

Then, the calculation unit 507 calculates a matching degree between the face and the specific fashion style, based on the calculated first feature vector and the specified first dictionary vector. For example, the calculation unit 507 calculates the matching degree between the face and the specific fashion style by calculating an inner product of the first feature vector and the first dictionary vector, using the following formula (1). However, X represents a matching degree. The reference v1 represents the first feature vector. The reference V1 represents the first dictionary vector.

X=|difference in AU value|=v1*V1 (1)

The matching degree obtained by a matching function in the above formula (1) corresponds to, for example, a difference in the AU value between captured images (input image P and captured image including face that matches specific fashion style).

Furthermore, the calculation unit 507 may calculate the matching degree between the face of the specific fashion style, based on the occurrence state of the action unit and the detected feature amount of the hair region. For example, the calculation unit 507 calculates a second feature vector representing an impression of the face, based on the occurrence state of the action unit and the feature amount of the hair region.

Here, it is assumed that the feature amount of the hair region be an average color of the hair region and a pixel occupancy ratio (ratio of hair region with respect to head region). In this case, the second feature vector is, for example, a 36-dimensional vector (R_value, G_value, B_value, hair_length, AU01_value, AU02_value, . . . , and AU46_value) whose elements are the average color of the hair region (RGB three dimensions), the pixel occupancy ratio (one dimension), the 32 types of AU values (32 dimensions).

Furthermore, the calculation unit 507 specifies a second dictionary vector representing the impression of the face that matches the specific fashion style, by referring to the storage unit 510. The storage unit 510 stores the second dictionary vector representing the impression of the face that matches the specific fashion style. The second dictionary vector is generated based on the occurrence state of the action unit based on the captured image including the face and the hair that match the specific fashion style and the feature amount of the hair region extracted from the captured image. For example, the second dictionary vector is a 36-dimensional vector whose elements are the average color of the hair region, the pixel occupancy ratio, and the 32 types of respective AU values.

Then, the calculation unit 507 calculates the matching degree between the face and the specific fashion style, based on the calculated second feature vector and the specified second dictionary vector. For example, the calculation unit 507 calculates the matching degree between the face and the specific fashion style by calculating an inner product of the second feature vector and the second dictionary vector, using the following formula (2). However, X represents a matching degree. The reference v2 represents the second feature vector. The reference V2 represents the second dictionary vector.

X=|difference in average color of hair region|+|different in length of hair region|+|difference in AU value|=v2*V2 (2)

The matching degree obtained by a matching function in the above formula (2) corresponds to, for example, a sum of the difference in the average color of the hair region, the difference in the length of the hair region, and the difference in the AU value between the captured images (input image P and captured image including face that matches specific fashion style).

However, the calculation unit 507 may normalize both of the second feature vector and the second dictionary vector and calculate an inner product of the normalized vectors, for example, using the following formula (2′).

X=v2/|v2|*V2/|V2| (2′)

Furthermore, the calculation unit 507 may calculate the matching degree between the face and the specific fashion style, based on the occurrence state of the action unit and the detected feature amount of the face part. For example, the calculation unit 507 calculates a third feature vector representing an impression of the face, based on the occurrence state of the action unit and the feature amount of the face part.

Here, it is assumed that the feature amounts of the face parts be positions of the eyes, the nose, the mouth, and the eyebrows in the face of the target person. In this case, the third feature vector is, for example, a 36-dimensional vector (AU01_value, AU02_value, . . . , AU46_value, eye_location, nose_location, mouth_location, and eyebrow_location) whose elements are the 32 types of AU values (32 dimensions), the eye positions (one dimension), the nose position (one dimension), the mouth position (one dimension), and the eyebrow positions (one dimension).

Furthermore, the calculation unit 507 specifies a third dictionary vector representing the impression of the face that matches the specific fashion style, by referring to the storage unit 510. The storage unit 510 stores the third dictionary vector representing the impression of the face that matches the specific fashion style. The third dictionary vector is generated based on the occurrence state of the action unit based on the captured image including the face that matches the specific fashion style and the feature amount of the face part extracted from the captured image. For example, the third dictionary vector is a 36-dimensional vector whose elements are the 32 types of the respective AU values, the eye positions, the nose position, the mouth position, and the eyebrow positions.

Then, the calculation unit 507 calculates the matching degree between the face and the specific fashion style, based on the calculated third feature vector and the specified third dictionary vector. For example, the calculation unit 507 calculates the matching degree between the face and the specific fashion style by calculating an inner product of the third feature vector and the third dictionary vector, using the following formula (3). However, X represents a matching degree. The reference v3 represents the third feature vector. The reference V3 represents the third dictionary vector.

X=|difference in AU value|+|difference in face part|=v3*V3 (3)

The matching degree obtained by a matching function in the above formula (3) corresponds to, for example, a sum of the difference in the AU value and the difference in the face part between the captured images (input image P and captured image including face that matches specific fashion style).

However, the calculation unit 507 may normalize both of the third feature vector and the third dictionary vector and calculate an inner product of the normalized vectors, for example, using the following formula (3′).

X=v3/|v3|*V3/|V3| (3′)

Furthermore, the calculation unit 507 may calculate the matching degree between the face and the specific fashion style, based on the occurrence state of the action unit, the feature amount of the hair region, and the feature amount of the face part. For example, the calculation unit 507 calculates a fourth feature vector representing an impression of the face, based on the occurrence state of the action unit, the feature amount of the hair region, and the feature amount of the face part.

The fourth feature vector is, for example, a 40-dimensional vector whose elements are the average color of the hair region, the pixel occupancy ratio of the hair region, the 32 types of the AU values, the eye positions, the nose position, the mouth position, and the eyebrow positions (R_value, G_value, B_value, hair_length, AU01_value, AU02_value, . . . , AU46_value, eye_location, nose_location, mouth_location, and eyebrow_location).

Furthermore, the calculation unit 507 specifies a fourth dictionary vector representing the impression of the face that matches the specific fashion style, by referring to the storage unit 510. The storage unit 510 stores the fourth dictionary vector representing the impression of the face that matches the specific fashion style. The fourth dictionary vector is generated based on the occurrence state of the action unit based on the captured image including the face and the hair that match the specific fashion style, the feature amount of the hair region extracted from the captured image, and the feature amount of the face part extracted from the captured image.

For example, the fourth dictionary vector is a 40-dimensional vector whose elements are the average color of the hair region, the pixel occupancy ratio of the hair region, the 32 types of the respective AU values, the eye positions, the nose position, the mouth position, and the eyebrow positions.

More specifically, for example, the calculation unit 507 specifies style dictionary information corresponding to the specific fashion style by referring to the style dictionary DB 220. Then, the calculation unit 507 specifies the fourth dictionary vector, based on the specified style dictionary information.

For example, it is assumed that the specific fashion style be “Bohemian” and the style dictionary information 400-1 to 400-3 corresponding to Bohemian be specified. In this case, the calculation unit 507 specifies the fourth dictionary vector (30, 20, 3.3, 30, 1.7, . . . , 1.3, 6.3, 7.6, 18.6, 17) by calculating an average of each dimension of the dictionary vectors of the style dictionary information 400-1 to 400-3. Furthermore, the calculation unit 507 may specify the dictionary vector of one of the pieces of the style dictionary information 400-1 to 400-3 as the fourth dictionary vector. Furthermore, the calculation unit 507 may specify the dictionary vector of each piece of the style dictionary information 400-1 to 400-3 as the fourth dictionary vector.

Furthermore, for example, it is assumed that the specific fashion style be “Goth” and style dictionary information 400-11 to 400-13 corresponding to Goth be specified. In this case, the calculation unit 507 specifies the fourth dictionary vector (13.3, 21.6, 13.3, 22.3, 1.36, . . . , 1.76, 5, 18, 35.3, 12.3) by calculating an average of each dimension of the dictionary vectors of the style dictionary information 400-11 to 400-13. Furthermore, the calculation unit 507 may specify the dictionary vector of one of the pieces of the style dictionary information 400-11 to 400-13 as the fourth dictionary vector. Furthermore, the calculation unit 507 may specify the dictionary vector of each piece of the style dictionary information 400-11 to 400-13 as the fourth dictionary vector.

Then, the calculation unit 507 calculates the matching degree between the face and the specific fashion style, based on the calculated fourth feature vector and the specified fourth dictionary vector. For example, the calculation unit 507 calculates the matching degree between the face and the specific fashion style by calculating an inner product of the fourth feature vector and the fourth dictionary vector, using the following formula (4). However, X represents a matching degree. The reference v4 represents the fourth feature vector. The reference V4 represents the fourth dictionary vector.

X=|difference in average color of hair region|+|difference in length of hair region|+|difference in AU value|+|difference in face part|=v4*V4 (4)

The matching degree obtained by a matching function in the above formula (4) corresponds to, for example, a sum of the difference in the average color of the hair region, the difference in the length of the hair region, the difference in the AU value, and the difference in the face part between the captured images.

For example, it is assumed that the specific fashion style be “Bohemian” and the fourth dictionary vector be (30, 20, 3.3, 30, 1.7, . . . , 1.3, 6.3, 7.6, 18.6, 17). Furthermore, it is assumed that the fourth feature vector calculated from the input image P be (25, 23, 7.3, 23, 1.9, . . . , 2.3, 8, 10, 20, 15). In this case, the matching degree X is an inner product value calculated from (30, 20, 3.3, 30, 1.7, . . . , 1.3, 6.3, 7.6, 18.6, 17)*(25, 23, 7.3, 23, 1.9, . . . , 2.3, 8, 10, 20, 15). A larger value of the matching degree X indicates a higher matching degree with the Bohemian style, and a lower value of the matching degree X indicates a lower matching degree with the Bohemian style.

However, the calculation unit 507 may normalize both of the fourth feature vector and the fourth dictionary vector and calculate an inner product of the normalized vectors, for example, using the following formula (4′).

X=v4/|v4|*V4/|V4| (4′)

In this case, for example, if the matching degree X is a value of zero to one, and as the matching degree X is closer to one, this indicates that the matching degree with the Bohemian style is higher. Furthermore, as the matching degree X is closer to zero, this indicates that the matching degree with the Bohemian style is lower.

Note that, in a case where the plurality of fourth dictionary vectors is specified, for example, the calculation unit 507 may specify one of an average value, a maximum value, or a minimum value of the matching degrees based on the fourth feature vector and the fourth dictionary vectors as the matching degree between the face and the specific fashion style.

The output unit 508 outputs the calculated matching degree. For example, the output unit 508 outputs the matching degree between the face of the target person with the specific fashion style, in association with the input image P. An output format of the output unit 508 is, for example, storage in the storage device such as the memory 302 or the disk 304, transmission to another computer (for example, client device 201) by the communication I/F 305, display on a display (not illustrated), print output to a printer (not illustrated), or the like.

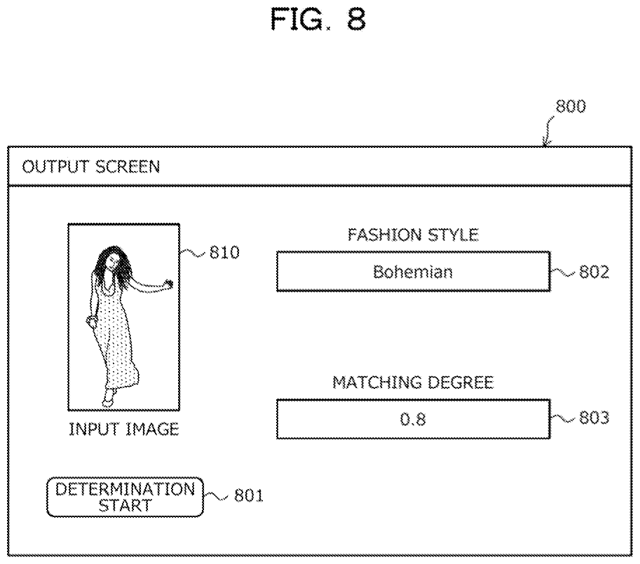

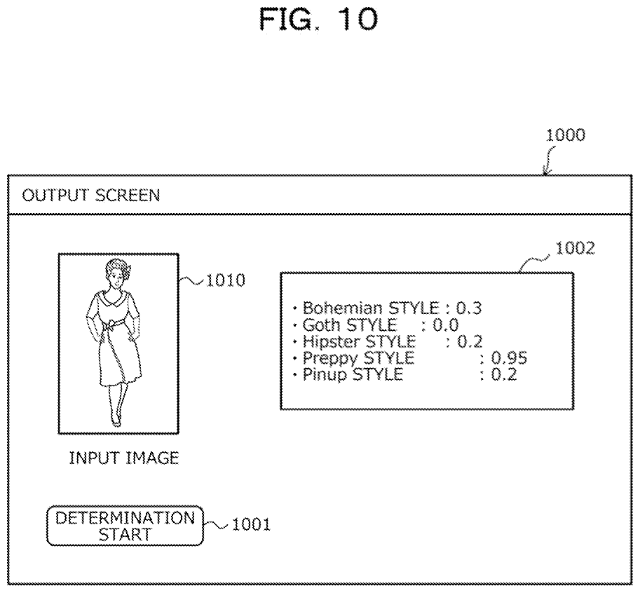

More specifically, for example, the output unit 508 may output the calculated matching degree between the face and the specific fashion style to output screens 800 and 1000 as illustrated in FIGS. 8 and 10 to be described later.

Note that the acquisition unit 501 may acquire a plurality of captured images (input image P) including faces with various expressions of the same person. In this case, for example, the calculation unit 507 may use an average value of values based on each of the plurality of captured images, as a value of each element of the feature vectors (first to fourth feature vectors).

(Calculation Processing Procedure of Information Processing Device 101)

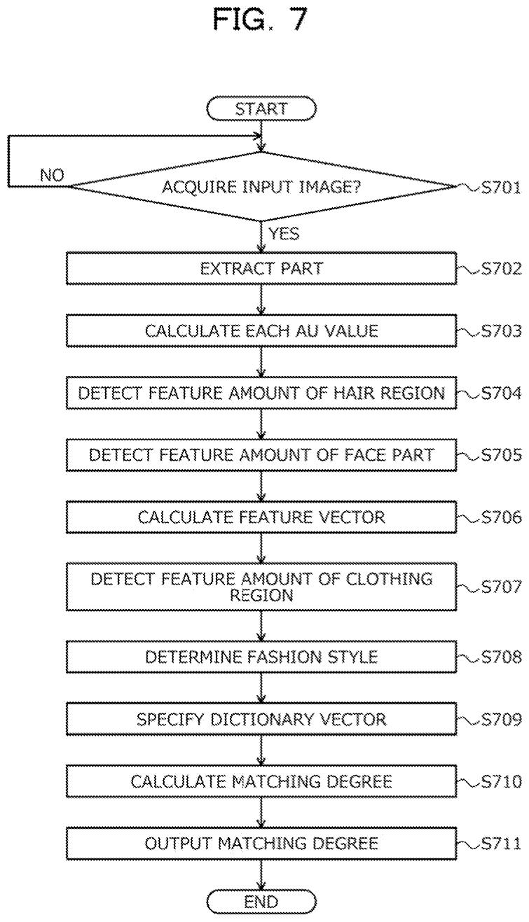

Next, a calculation processing procedure of the information processing device 101 will be described. Here, first, a first calculation processing procedure of the information processing device 101 will be described with reference to FIG. 7.

FIG. 7 is a flowchart illustrating an example of the first calculation processing procedure of the information processing device 101. In the flowchart in FIG. 7, first, the information processing device 101 determines whether or not the input image P is acquired (step S701). Here, the information processing device 101 waits for acquisition of the input image P (step S701: No).

Then, in a case of acquiring the input image P (step S701: Yes), the information processing device 101 extracts parts from the acquired input image P (step S702). The parts to be extracted are a face region, a hair region, a head region, and a clothing region. Next, the information processing device 101 calculates each AU value based on the extracted face region (step S703).

Next, the information processing device 101 detects a feature amount of the extracted hair region (step S704). Next, the information processing device 101 detects a feature amount of the face part based on the extracted face region (step S705). Then, the information processing device 101 calculates a feature vector representing an impression of the face, based on each AU value, the feature amount of the hair region, and the feature amount of the face part (step S706). The feature vector to be calculated is, for example, the fourth feature vector described above.

Next, the information processing device 101 detects a feature amount of the extracted clothing region (step S707). Then, the information processing device 101 determines a fashion style corresponding to the clothing region, based on the detected feature amount of the clothing region (step S708). Next, the information processing device 101 specifies a dictionary vector of the determined fashion style, by referring to the style dictionary DB 220 (step S709). The dictionary vector to be specified is, for example, the fourth dictionary vector described above.

Next, the information processing device 101 calculates a matching degree between the face and the fashion style by calculating an inner product of the calculated feature vector and the specified dictionary vector (step S710). Then, the information processing device 101 outputs the calculated matching degree between the face and the fashion style (step S711) and ends the series of processing according to this flowchart.

As a result, it is possible to output the matching degree indicating how much the impression of the face of the target person imaged in the input image P matches the fashion style determined from the input image P.

Here, a screen example of an output screen output as a result of executing the first calculation processing will be described with reference to FIG. 8. The output screen is displayed, for example, on a display (not illustrated) of the client device 201.

FIG. 8 is an explanatory diagram (part 1) illustrating a screen example of an output screen. When an input image 810 is set and a determination start button 801 is selected in the output screen 800, a fashion style determined from the input image 810 is displayed in a box 802. Furthermore, in a box 803, a matching degree with the fashion style calculated from the input image 810 is displayed.

Here, in the box 802, Bohemian determined from the input image 810 is displayed. Furthermore, in the box 803, a matching degree “0.8” between the face imaged in the input image 810 with the Bohemian style is displayed.

According to the output screen 800, a user can determine how much an impression of the face of the target person imaged in the input image 810 matches the Bohemian style determined from the input image 810. Here, since the matching degree is a high value of “0.8”, it is found that the impression of the face is well suited to the Bohemian style.

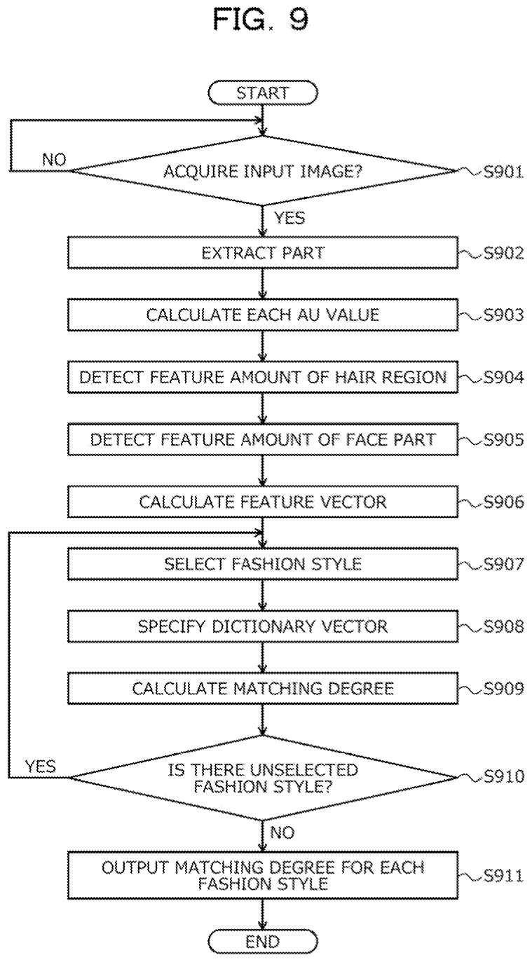

Next, a second calculation processing procedure of the information processing device 101 will be described with reference to FIG. 9.

FIG. 9 is a flowchart illustrating an example of the second calculation processing procedure of the information processing device 101. In the flowchart in FIG. 9, first, the information processing device 101 determines whether or not the input image P is acquired (step S901). Here, the information processing device 101 waits for acquisition of the input image P (step S901: No).

Then, in a case of acquiring the input image P (step S901: Yes), the information processing device 101 extracts parts from the acquired input image P (step S902). The parts to be extracted are a face region, a hair region, and a head region. Next, the information processing device 101 calculates each AU value based on the extracted face region (step S903).

Next, the information processing device 101 detects a feature amount of the detected hair region (step S904). Next, the information processing device 101 detects a feature amount of the face part based on the extracted face region (step S905). Then, the information processing device 101 calculates a feature vector representing an impression of the face, based on each AU value, the feature amount of the hair region, and the feature amount of the face part (step S906).

Next, the information processing device 101 selects an unselected fashion style that is not selected by referring to the style dictionary DB 220 (step S907). Next, the information processing device 101 specifies a dictionary vector of the selected fashion style by referring to the style dictionary DB 220 (step S908).

Next, the information processing device 101 calculates a matching degree between the face and the fashion style by calculating an inner product of the calculated feature vector and the specified dictionary vector (step S909). Then, the information processing device 101 determines whether or not there is an unselected fashion style that is not selected, by referring to the style dictionary DB 220 (step S910).

Here, in a case where there is an unselected fashion style (step S910: Yes), the information processing device 101 returns to step S907. On the other hand, in a case where there is no unselected fashion style (step S910: No), the information processing device 101 outputs the calculated matching degree for each fashion style (step S911) and ends the series of processing according to this flowchart.

As a result, it is possible to output the matching degree indicating how much the impression of the face of the target person imaged in the input image P matches each fashion style.

Here, a screen example of an output screen output as a result of executing the second calculation processing will be described with reference to FIG. 10.

FIG. 10 is an explanatory diagram (part 2) illustrating a screen example of an output screen. In the output screen 1000, when an input image 1010 is set and a determination start button 1001 is selected, a matching degree with each fashion style calculated from the input image 1010 is displayed in a box 1002.

Here, in the box 1002, each matching degree between the face imaged in the input image 1010 with each of fashion styles of Bohemian, Goth, Hipster, Preppy, and Pinup is displayed.

According to the output screen 1000, a user can determine how much an impression of the face of the target person imaged in the input image 1010 matches each fashion style. Here, since the matching degree with the Preppy style is the highest value of “0.95”, it is found that the impression of the face is well suited to the Preppy style.

As described above, according to the information processing device 101 according to the embodiment, it is possible to acquire the input image P, determine the occurrence state of the action unit (movement of facial muscle) based on the input image P, and calculate the matching degree between the face and the specific fashion style based on the occurrence state of the action unit. Then, according to the information processing device 101, it is possible to output the calculated matching degree.

As a result, it is possible to estimate the impression of the face of the target person imaged in the input image P, using the occurrence state of the action unit representing the face muscle condition, and to output the matching degree indicating how much the impression of the face matches the specific fashion style.

Furthermore, according to the information processing device 101, it is possible to detect the feature amount of the clothing region corresponding to the face from the input image P and determine the fashion style corresponding to the clothing region, based on the detected feature amount of the clothing region. Then, according to the information processing device 101, it is possible to calculate the matching degree between the face and the determined fashion style based on the occurrence state of the action unit.

As a result, it is possible to output the matching degree indicating how much the impression of the face matches the fashion style determined from the input image P.

Furthermore, according to the information processing device 101, it is possible to detect the feature amount of the hair region corresponding to the face from the input image P and calculate the matching degree between the face and the specific fashion style based on the occurrence state of the action unit and the feature amount of the hair region. The feature amount of the hair region is, for example, information based on at least one of the average color of the hair region and the ratio of the hair region with respect to the head region including the hair region and the face region.

As a result, it is possible to estimate the impression of the face of the target person imaged in the input image P using not only the occurrence state of the action unit but also the color, the length, or the like of the hair as features.

Furthermore, according to the information processing device 101, it is possible to detect the feature amount of the face part from the input image P and calculate the matching degree between the face and the specific fashion style based on the occurrence state of the action unit and the feature amount of the face part. The feature amount of the face part represents, for example, a position of the face part in the face (face region).

As a result, it is possible to estimate the impression of the face of the target person imaged in the input image P using not only the occurrence state of the action unit but also a position relationship of the face parts as features.

Furthermore, according to the information processing device 101, it is possible to calculate the first feature vector representing the impression of the face, based on the occurrence state of the action unit. Then, according to the information processing device 101, it is possible to calculate the matching degree between the face and the specific fashion style based on the calculated first feature vector and the first dictionary vector representing the impression of the face that matches the specific fashion style, by referring to the storage unit 510. The first dictionary vector is generated based on the occurrence state of the action unit based on the captured image including the face that matches the specific fashion style.

As a result, it is possible to represent the difference in the AU value as an inter-vector distance and to obtain the matching degree between the face and the specific fashion style from the similarity degree between the feature vector and the dictionary vector.

Furthermore, according to the information processing device 101, it is possible to calculate the second feature vector representing the impression of the face, based on the occurrence state of the action unit and the feature amount of the hair region. Then, according to the information processing device 101, it is possible to calculate the matching degree between the face and the specific fashion style based on the calculated second feature vector and the second dictionary vector representing the impression of the face that matches the specific fashion style, by referring to the storage unit 510. The second dictionary vector is generated based on the occurrence state of the action unit based on the captured image including the face and the hair that match the specific fashion style and the feature amount of the hair region extracted from the captured image.

As a result, by representing not only the difference in the AU value but also the difference in the hair color or length as an inter-vector distance, it is possible to obtain the matching degree between the face and the specific fashion style from the similarity degree between the feature vector and the dictionary vector.

Furthermore, according to the information processing device 101, it is possible to calculate the third feature vector representing the impression of the face, based on the occurrence state of the action unit and the feature amount of the face part. Then, according to the information processing device 101, it is possible to calculate the matching degree between the face and the specific fashion style based on the calculated third feature vector and the third dictionary vector representing the impression of the face that matches the specific fashion style, by referring to the storage unit 510. The third dictionary vector is generated based on the occurrence state of the action unit based on the captured image including the face that matches the specific fashion style and the feature amount of the face part detected from the captured image.

As a result, it is possible to represent not only the difference in the AU value but also differences in the positions of the face parts such as the eyes, the nose, the mouth, or the eyebrows as an inter-vector distance and to obtain the matching degree between the face and the specific fashion style from the similarity degree between the feature vector and the dictionary vector.

From these, according to the information processing device 101, it is possible to quantitatively evaluate how much the impression of the face of the target person matches the specific fashion style, from the captured image including the face, the hair, and the clothing of the target person. As a result, for example, it is possible to evaluate how much the impression of the face of the model matches the target fashion style and check the content of the photographs to be published in the fashion magazines. Furthermore, a user can determine which fashion style matches an impression of the user's face. Furthermore, the impression of the face changes depending on makeup. Therefore, when clothing of the specific fashion style matches makeup, it is possible to obtain an index that can quantitatively evaluate how much the makeup matches the specific fashion style, and for example, the index can be useful for development of cosmetics or the like.

Note that the calculation method described in the present embodiment may be implemented by a computer such as a personal computer or a workstation executing a program prepared in advance. The calculation program is recorded on a computer-readable recording medium such as a hard disk, a flexible disk, a CD-ROM, a DVD, or a USB memory, and is read from the recording medium to be executed by the computer. Furthermore, the calculation program may be distributed via a network such as the Internet.

Furthermore, the information processing device 101 described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a calculation program for causing a computer to execute processing comprising:
acquiring a captured image that includes a face;
determining an occurrence state of a movement of a facial muscle, based on the captured image; and
calculating a matching degree between the face and a specific fashion style, based on the occurrence state of the movement of the facial muscle.

2. The non-transitory computer-readable recording medium according to claim 1, for causing the computer to execute processing comprising:
detecting a feature amount of a clothing region that corresponds to the face from the captured image; and
determining a fashion style that corresponds to the clothing region, based on the detected feature amount of the clothing region, wherein
the specific fashion style is a fashion style that corresponds to the determined clothing region.

3. The non-transitory computer-readable recording medium according to claim 1, for causing the computer to execute processing comprising:
detecting a feature amount of a hair region that corresponds to the face from the captured image, wherein
the calculating processing includes processing of calculating a matching degree between the face and the specific fashion style, based on the occurrence state of the movement of the facial muscle and the detected feature amount of the hair region.

4. The non-transitory computer-readable recording medium according to claim 3, wherein
the feature amount of the hair region is based on at least one of an average color of the hair region and a ratio of the hair region with respect to a head region that includes the hair region and a face region.

5. The non-transitory computer-readable recording medium according to claim 1, for causing the computer to execute processing comprising:
detecting a feature amount of a part of the face from the captured image, wherein
the calculating processing includes processing of calculating a matching degree between the face and the specific fashion style, based on the occurrence state of the movement of the facial muscle and the detected feature amount of the part of the face.

6. The non-transitory computer-readable recording medium according to claim 5, wherein
the feature amount of the part of the face is based on a position of the part in the face.

7. The non-transitory computer-readable recording medium according to claim 1, wherein
the calculating processing includes
calculating a first feature vector that represents an impression of the face, based on the occurrence state of the movement of the facial muscle, and
referring to a storage unit that stores a first dictionary vector that represents an impression of a face that matches the specific fashion style and calculating a matching degree between the face and the specific fashion style based on the calculated first feature vector and the first dictionary vector.

8. The non-transitory computer-readable recording medium according to claim 7, wherein
the first dictionary vector is generated based on an occurrence state of a movement of a facial muscle based on a captured image that includes the face that matches the specific fashion style.

9. The non-transitory computer-readable recording medium according to claim 3, wherein
the calculating processing includes
calculating a second feature vector that represents an impression of the face, based on the occurrence state of the movement of the facial muscle and the feature amount of the hair region, and
referring to a storage unit that stores a second dictionary vector that represents an impression of a face that matches the specific fashion style and calculating a matching degree between the face and the specific fashion style based on the calculated second feature vector and the second dictionary vector.

10. The non-transitory computer-readable recording medium according to claim 9, wherein
the second dictionary vector is generated based on an occurrence state of a movement of a facial muscle based on a captured image that includes the face and hair that match the specific fashion style and a feature amount of the hair region extracted from the captured image.

11. The non-transitory computer-readable recording medium according to claim 5, wherein
the calculating processing includes
calculating a third feature vector that represents an impression of the face, based on the occurrence state of the movement of the facial muscle and the feature amount of the part of the face, and
referring to a storage unit that stores a third dictionary vector that represents an impression of the face that matches the specific fashion style and calculating a matching degree between the face and the specific fashion style, based on the calculated third feature vector and the third dictionary vector.

12. The non-transitory computer-readable recording medium according to claim 11, wherein
the third dictionary vector is generated based on an occurrence state of a movement of a facial muscle based on a captured image that includes the face that matches the specific fashion style and the feature amount of the part of the face detected from the captured image.

13. The non-transitory computer-readable recording medium according to claim 1, wherein
the movement of the facial muscle is an action unit.

14. A calculation method comprising:
acquiring a captured image that includes a face;
determining an occurrence state of a movement of a facial muscle, based on the captured image; and
calculating a matching degree between the face and a specific fashion style, based on the occurrence state of the movement of the facial muscle.

15. An information processing device comprising:
a memory; and
a processor coupled to the memory and configured to:
acquire a captured image that includes a face;
determine an occurrence state of a movement of a facial muscle, based on the captured image; and
calculate a matching degree between the face and a specific fashion style, based on the occurrence state of the movement of the facial muscle.
